(19) United States
(12) Patent Application Publication
(10) Pub. No.: US 2025/0371609 A1
(43) Pub. Date: Dec. 4, 2025

(54) MULTI-PLATFORM ONLINE AUCTION WITH CONTINUOUS BIDDING SYSTEMS AND METHODS

(71) Applicant: Stellantis Financial Services, Inc., Atlanta, GA (US)

(72) Inventor: Daniel Heinrich, Houston, TX (US)

(21) Appl. No.: 19/206,324

(22) Filed: May 13, 2025

Related U.S. Application Data
(60) Provisional application No. 63/653,468, filed on May 30, 2024.

(51) Int. Cl. G06Q 30/08

(52) U.S. Cl. CPC G06Q 30/08

(57) ABSTRACT

Multi-platform online auction systems and methods are disclosed. A method can include: receiving an instruction to list an item on first and second online auction platforms, the instruction including information associated with the item; generating, via a decision engine, first listing data for the item that is based at least in part on the information and at least in part on rules-based data corresponding to information associated with the first online auction platform; communicating, via a secure communications protocol, the first listing data to the first online auction platform; generating, via the decision engine, second listing data for the item that is based at least in part on the information associated with the item and at least in part on rules-based data corresponding to information associated with the second online auction platform; and communicating, via the secure communications protocol, the second listing data to the second online auction platform.

### CROSS-REFERENCE TO RELATED APPLICATIONS

This application claims the benefit of U.S. Provisional Application Ser. No. 63/653,468, filed on 30 May 2024, which is incorporated herein by reference in its entirety as if fully set forth below.

### FIELD OF THE DISCLOSURE

The various embodiments of the present disclosure relate generally to online auctions, and more particularly to multi-platform online auctions with continuous bidding.

### BACKGROUND

With the introduction and acceptance of online auctions, exposure to buyers from the traditional physical auctions has dramatically expanded. The number of buyers is no longer limited to a specific geographic location that can only participate in an auction at a certain location on a specific day and at a given time. Even with the adoption of online auctions, there is still a limitation in the exposure of inventory to a broader audience because the buyer is only viewing a single online auction and is limited to the inventory available from that one online auction platform. The standardization around availability of products/items/assets/services offered simultaneously across multiple online auction platforms would create a better buyer and seller experience.

Currently, consignors (sellers) post their products primarily on a single online auction platform to get competitive bidding. Because the process is very linear, if a consignor chooses to move to a different online auction provider, it adds deprecation costs, additional time to the process, and potentially operational expenses. The current structure of only having a single auction platform to utilize creates a limited audience to the consignor's product inventory and limits availability of options for the buyer. Buyers are often forced to access different online auctions on their respective different online auction platforms to search for inventory, creating inefficiencies in sourcing products due to, inter alia, a disjointed view of options across multiple online auction platforms. A seller will often select one online auction platform over another because of either the inventory offered by the seller or currently on the platform, the services provided by the seller or the platform, the options available for the seller or buyer on the platform, or simply out of seller habit. Accordingly, there is a need for an improved online auction that leverages multiple online auction platforms.

### BRIEF SUMMARY

An exemplary embodiment of the present disclosure provides a multi-platform online auction method comprising: receiving an instruction to list an item on a first online auction platform and a second online auction platform, the instruction comprising information associated with the item; generating, via a decision engine, first listing data for the item, the first listing data based at least in part on the information associated with the item and at least in part on rules-based data corresponding to information associated with the first online auction platform; communicating, via a secure communications protocol, the first listing data to the first online auction platform; generating, via the decision engine, second listing data for the item, the second listing data based at least in part on the information associated with the item and at least in part on rules-based data corresponding to information associated with the second online auction platform; and communicating, via the secure communications protocol, the second listing data to the second online auction platform.

In any of the embodiments disclosed herein, the information associated with the item can comprise at least one item parameter selected from the group consisting of an authentication parameter, inventory data parameter, and pricing parameter.

In any of the embodiments disclosed herein, the information associated with the first online auction platform can comprise at least one platform parameter selected from the group consisting of a platform-specific identifier, seller identifier, platform-specific timing/bidding detail, platform-specific authentication, platform-specific inventory data, platform-specific pricing information, platform-specific callback, platform-specific business rule, platform-specific security measure, platform-specific metadata, and platform-specific time zone.

In any of the embodiments disclosed herein, the rules-based data corresponding to information associated with the first online auction platform can be at least in part different than the rules-based data corresponding to information associated with the second online auction platform.

In any of the embodiments disclosed herein, a time difference can exist between operation of the first online auction platform and operation of the second online auction platform. The rules-based data corresponding to information associated with the first online auction platform and the rules-based data corresponding to information associated with the second online auction platform can consider the time difference in synchronizing bidding between the first online auction platform and the second online auction platform, thereby aligning bids between the first online auction platform and the second online auction platform within a unified timeline.

In any of the embodiments disclosed herein, the method can further comprise: receiving, at the decision engine, via the secure communications protocol, updated information associated with the item listed on the first online auction platform; generating, via the decision engine, updated second listing data for the item, the updated second listing data based at least in part on the updated information associated with the item listed on the first online auction platform and at least in part on the rules-based data corresponding to the information associated with the second online auction platform; and communicating, via the secure communications protocol, the updated second listing data to the second online auction platform.

In any of the embodiments disclosed herein, the updated information associated with the item listed on the first online auction platform can comprise a current bid price on the first online auction platform.

In any of the embodiments disclosed herein, the rules-based data corresponding to information associated with the first online auction platform comprises a current bidding increment on the first online auction platform, and wherein the rules-based data corresponding to information associated with the second online auction platform comprises a bidding increment on the second online auction platform that can be adjusted to match the current bidding increment on the first online auction platform, whereby the updated second listing data comprises the current bid price on the first online auction platform and the current bidding increment on the first online auction platform.

In any of the embodiments disclosed herein, the secure communications protocol can utilize a secure gateway.

In any of the embodiments disclosed herein, the secure communications protocol can comprise an application programming interface (API) layer.

In any of the embodiments disclosed herein, a non-transitory computer readable storage medium can store computer code which, when executed by a processor, can perform any of the methods according to any of the embodiments disclosed above.

In any of the embodiments disclosed herein, the method can further comprise: identifying, via the decision engine, limited bidding on the item on either the first online auction platform using the rules-based data corresponding to information associated with the first online auction platform or the second online auction platform using the rules-based data corresponding to information associated with the second online auction platform; generating, via the decision engine, third listing data for the item, the third listing data based at least in part on the information associated with the item and at least in part on rules-based data corresponding to information associated with a third online auction platform; and communicating, via the secure communications protocol, the third listing data to the third online auction platform.

In any of the embodiments disclosed herein, the method can further comprise: generating, via the decision engine, instructions to remove the first listing data from the first online auction platform or the second listing data from the second online auction platform, based on the identification of the limited bidding on the item; and communicating, via the secure communications protocol, the instructions to the first online auction platform to remove the first listing data, or the instructions to the second online auction platform to remove the second listing data.

Another embodiment of the present disclosure provides a multi-platform online auction system comprising a processor and a memory. The memory can be coupled to the processor to store code, which when executed by the processor, causes the processor to perform operations. The operations can comprise: receiving an instruction to list an item on a first online auction platform and a second online auction platform, the instruction comprising information associated with the item; generating, via a decision engine, first listing data for the item, the first listing data based at least in part on the information associated with the item and at least in part on rules-based data corresponding to information associated with the first online auction platform; communicating, via a secure communications protocol, the first listing data to the first online auction platform; generating, via the decision engine, second listing data for the item, the second listing data based at least in part on the information associated with the item and at least in part on rules-based data corresponding to information associated with the second online auction platform; and communicating, via the secure communications protocol, the second listing data to the second online auction platform.

In any of the embodiments disclosed herein, the operations can further comprise: receiving, at the decision engine, via the secure communications protocol, updated information associated with the item listed on the first online auction platform; generating, via the decision engine, updated second listing data for the item, the updated second listing data based at least in part on the updated information associated with the item listed on the first online auction platform and at least in part on the rules-based data corresponding to the information associated with the second online auction platform; and communicating, via the secure communications protocol, the updated second listing data to the second online auction platform.

In any of the embodiments disclosed herein, the operations can further comprise: identifying, via the decision engine, limited bidding on the item on either the first online auction platform using the rules-based data corresponding to information associated with the first online auction platform or the second online auction platform using the rules-based data corresponding to information associated with the second online auction platform; generating, via the decision engine, third listing data for the item, the third listing data based at least in part on the information associated with the item and at least in part on rules-based data corresponding to information associated with a third online auction platform; and communicating, via the secure communications protocol, the third listing data to the third online auction platform.

In any of the embodiments disclosed herein, the operations can further comprise: generating, via the decision engine, instructions to remove the first listing data from the first online auction platform or the second listing data from the second online auction platform, based on the identification of the limited bidding on the item; and communicating, via the secure communications protocol, the instructions to the first online auction platform to remove the first listing data, or the instructions to the second online auction platform to remove the second listing data.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic block diagram of a system for management of a multi-platform online auction with continuous bidding, in accordance with some embodiments of the present disclosure.

FIG. 2 provides a schematic block diagram of a module for management of a multi-platform online auction with continuous bidding, in accordance with some embodiments of the present disclosure.

FIG. 3 provides a schematic block diagram of another module for management of a multi-platform online auction with continuous bidding, in accordance with some embodiments of the present disclosure.

FIG. 4 provides a flowchart of a method for management of a multi-platform online auction with continuous bidding.

FIG. 5A provides a first portion of a flowchart of a method for management of a multi-platform online auction with continuous bidding.

FIG. 5B provides a second portion of a flowchart of a method for management of a multi-platform online auction with continuous bidding.

FIG. 5C provides a third portion of a flowchart of a method for management of a multi-platform online auction with continuous bidding.

FIG. 6 provides a flowchart of a method for management of a multi-platform online auction with continuous bidding, in accordance with some embodiments of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules (e.g., designed for implementation within a Software-as-a-Service (SaaS) platform), in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors (e.g., within an SaaS environment). An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on one or more computer readable medium(s).

The computer readable medium may be a tangible computer readable storage medium storing the program code. And the program code may be stored and accessed within, for example, an SaaS platform, utilizing cloud storage options such as databases or object storage. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

In one embodiment, the computer readable medium may comprise a combination of one or more computer readable storage mediums and one or more computer readable signal mediums. In an example, the program code may be distributed across different components of an SaaS infrastructure, including both storage and communication mediums. In another example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages (such as programming language(s) commonly used in SaaS development and executed within an SaaS environment), including an object oriented programming language such as VB.net, C#, .NET, Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In an example, aspects of the present invention such as the computer program product may utilize a 3^{rd} party SaaS platform for data exchange and processing, allowing users to securely storage, access, and analyze real-time data. The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may, for example, be integrated into a client, server, network environment, cloud hosting (e.g., PaaS, IaaS) and/or with or within other SaaS applications and services, by providing for the computer program product to coexist with applications, operating systems and network operating systems software and then installing the computer program product on the clients and servers in the environment where the computer program product will function. The architecture of the system may, for example, leverage cloud-based infrastructure provided by a 3^{rd} party SaaS platform, enabling seamless scalability and flexibility in resource allocation.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

For purposes of this disclosure, the terms “item”, “product”, “vehicle”, and “asset” (and respective derivatives thereof) may all be used interchangeably.

For purposes of this disclosure, the terms “seller”, “consignor”, and “dealer” (and respective derivatives thereof) may all be used interchangeably.

For purposes of this disclosure, the terms “buyer” and “bidder” (and respective derivatives thereof) may be used interchangeably.

For purposes of this disclosure, the phrases “web services”, “application programming interfaces (APIs)”, and “secure communications protocol” (and respective derivatives thereof) may all be used interchangeably.

Embodiments described herein provide a system and method for seamlessly integrating auctions across diverse online auction platforms through a robust secure communications protocol (e.g., an API layer). Continuous bidding is introduced, yielding substantial improvements including reduced cycle time, expanded online sales channels, enhanced adaptability to market changes, and the potential for vertical integration. A decision engine, empowered by, for example, business rules, orchestrates simultaneous postings on various platforms, particularly in the realm of bidding rules to govern most, if not all, of the entire process.

The overall system architecture serves as a data aggregation framework. Consignors maintain autonomy over their inventory management systems, leveraging a secure communications protocol utilizing a secured gateway to seamlessly transmit data to the decision engine. The decision engine, equipped with, for example, (potentially intricate) business or other rules, can function as the central intelligence that processes and optimizes the aggregated inventory data. The decision engine can be equipped with logic that enables rule creation to control, inter alia, the flow of inventory and determine the next best actions. In some embodiments, the decision engine can use various machine learning (artificial intelligence) algorithms alone, or in combination with rules, to make determinations as to next best actions. To illustrate using an example, consider a scenario where the decision engine, with its adaptive logic, identifies limited bidding on a particular asset across multiple sites. In response, it dynamically pulls/removes the asset from these online auction platforms and strategically reposts it on a completely new online auction platform, maximizing exposure and optimizing bidding potential.

The secure communications protocol (e.g., API layer) can act as a versatile bridge for data exchange to/from the online auction platforms and to/from the decision engine. This can allow the decision engine to transmit unit data to the various online auction platforms including: product details, condition, location, pricing details, bidding increments and status. Bids can be efficiently transmitted to and from various online auction platforms allowing viewing and bidding from multiple auctions simultaneously via the secure communications protocol. The decision engine may be considered the source of truth and enables continuous bidding across the selected online auction platforms. The system architecture, via the decision engine, can be structured to accommodate the unique rules of each auction platform, pulling together, and providing a standardized and compatible framework. This comprehensive design can allow the system to serve as a dynamic aggregator, commonizing data from disparate sources and ensuring a synchronized, continuous bidding experience across a diverse landscape of online auction platforms.

Enabling synchronized, continuous bidding across multiple platforms will revolutionize the auction process for both sellers and buyers. Continuous bidding is a systematic and automated process allowing bids from different online auction platforms for the product being sold to be consistently accepted and updated in real-time. The bid data can be facilitated by the secure communications protocol (e.g., API layer) and the method involves seamless integration of the bids back to various online auction platforms or sales channels. The continuous nature of this bidding mechanism can allow for participants to submit bids at any time, fostering dynamic and concurrent engagement across the diverse online auction platforms involved in the auction ecosystem.

More specifically, in one embodiment, bid coordination across multiple online auction platforms can be managed seamlessly through the integration of the API layer and the rules-based data (via the decision engine). The API layer can act as a bridge, facilitating real-time bid data exchange between the decision engine and diverse online auction platforms. The bidding process will facilitate the bidder submitting a bid on their platform of choice. The bid details, including the bid amount and associated information, can be then transmitted through the API layer to the decision engine. The decision engine can dynamically interpret the bid details, considering the rules-based data, and transmit the coordinated bid details back through the API layer to the respective online auction platforms. This can ensure that the bid is executed on each online auction platform in a synchronized approach, adhering to the rules and strategies set by the decision engine. This integrated approach streamlines bid coordination, providing the bidder with a unified and responsive bidding process across multiple online auction platforms.

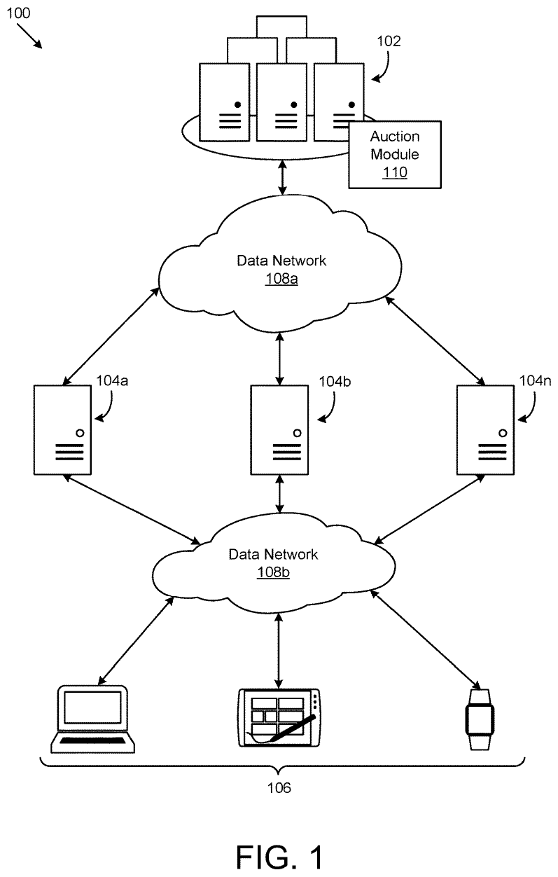

FIG. 1 provides a schematic block diagram of one embodiment of a system 100 for management of a multi-platform online auction with continuous bidding portal. In one embodiment, the system 100 includes one or more auction management devices 102 such as servers, desktop computers, laptop computers, or the like. In certain embodiments where the computing auction management devices 102 are servers, the servers may include blade servers, virtual servers, cloud servers, remote servers, network servers, or the like. The auction management devices 102 may be grouped into one or more physical groups, logical groups, functional groups, or the like. In some embodiments, the auction management devices 102 may be part of a data center and may be physically located in the same facility or in remote locations. Auction management devices 102, in certain embodiments, are configured to store, access, host, process, coordinate, synchronize, or the like, data associated with an online auction, as described below.

The system 100, in another embodiment, includes one or more computing devices 104a-n, such as servers, configured to be auction platforms. An auction platform 104a-n, as used herein, is a platform configured to host an online auction. An online auction may be an auction that is accessible via a network 108b, such as the Internet, an intranet, or the like. In one embodiment, the auction platforms 104a-n may present an interface, such as a web page, for users to post listings for items for sale, bid on items for sale, buy items for sale, view items for sale, or the like. In a traditional online auction, for example, a user may visit a web page where the auction is being hosted, view products that are for sale, and enter one or more bids on the products until a specified auction end time is reached. Generally, the user with the highest bid wins the auction and the opportunity to purchase the product for the bid price. In some embodiments, an auction platform 104a-n provides an option for a user to buy the item immediately (e.g., a “buy now” option), without bidding on the item and waiting for the auction end time to be reached. The auction platforms 104a-n may be configured to host auctions for various products, such as vehicles, electronics, tools, clothes, furniture, or the like.

In certain embodiments, users visit auction platforms 104a-n using one or more information handling devices 106, such as desktop computers, laptop computers, tablet computers, smart phones, smart watches or other wearable devices, smart TVs, or the like that are communicatively coupled to the auction platforms 104a-n via the network 108b. For example, a user may visit a web site hosted by an auction platform 104a-n using an iPad® or other tablet computer. The user may use the interface provided by the auction platform 104a-n to view items for sale, bid on an item for sale, complete a purchase for an item, or the like.

In one embodiment, the information handling devices 106 are communicatively coupled to one or more auction platforms 104a-n via a first data network 108b (i.e., network 108b). Similarly, the auction platforms 104a-n are communicatively coupled to the auction management devices 102 via a second data network 108a. In some embodiments, the first data network 108b is the same data network as the second data network 108a, such as the Internet. The data networks 108a, 108b, in one embodiment, comprise digital communication networks that transmit digital communications. The data networks 108a, 108b may include wireless networks, such as a wireless cellular networks, local wireless networks, such as Wi-Fi networks, Bluetooth® networks, near-field communication (NFC) networks, ad hoc networks, and/or the like. The data networks 108a, 108b may include wide area networks (WANs), storage area networks (SANs), local area networks (LANs), optical fiber networks, the internet, or other digital communication networks. The data networks 108a, 108b may include two or more networks. The data networks 108a, 108b may include one or more servers, routers, switches, and/or other networking equipment. The data network 108a, 108b may also include computer readable storage media, such as a hard disk drive, an optical drive, non-volatile memory, random access memory (RAM), or the like.

In some embodiments, auction platforms 104a-n are independent entities that do not communicate with each other. Thus, in certain embodiments, if a user desires to post a listing for an item at each auction platform 104a-n, the user may be required to create a separate product listing for the item on each auction platform 104a-n, which may be cumbersome and time consuming to create, monitor, and maintain. For example, a user that is selling his car may be required to create separate listings for his car on auction platform A, auction platform B, and auction platform C in order to generate the most exposure for his listing. However, the user may have to monitor each auction platform 104a-n to determine whether other users are bidding on his car, whether his car has been sold under a “buy now” option, or the like. Examples of different auction platforms 104a-n for vehicles may include ACV, eBlock, SmartAuction, Manheim OVE, Plug, and OpenLane.

Additionally, when the auction is finished, the user may be required to manually remove the listing from each auction platform 104a-n and/or re-post the listing for the car if the car did not sell. Furthermore, in various embodiments, when a bid for an item is received from a user on a particular auction platform 104a-n, listings for the item on different auction platforms 104a-n are removed such that the item may only be bid on and purchased by users of the auction platform 104a-n that entered the first bid.

On the other hand, the auction management devices 102, in certain embodiments, monitor, manage, coordinate, or the like, bidding activity among the different auction platforms 104a-n. In the example above, if a user were to bid on a car listing using auction platform A, instead of removing the car listing from other auction platforms 104a-n, the auction management devices 102 may update bid information for the listing on the other auction platforms 104a-n, such as the current bid price, thereby potentially increasing exposure of the listed auction item to more bidders across the multiple auction platforms, which is an improvement upon existing online auction systems. Furthermore, the auction management devices 102 manage reserve price and bid information such that when a reserve price for an auction item is met at one auction platform 1041-n, the auction management devices 102 can remove the listing for the auction item from the other auction platforms 104a-n while continuing the auction for the auction item at the auction platform 104a-n where the bid that met the reserve price is received. Alternatively, the auction management devices 102 can continue the listing for the auction item from the other auction platforms 104a-n while continuing the auction for the auction item at the auction platform 104a-n where the bid that met the reserve price is received, thereby potentially increasing exposure of the listed auction item to more bidders across the multiple auction platforms.

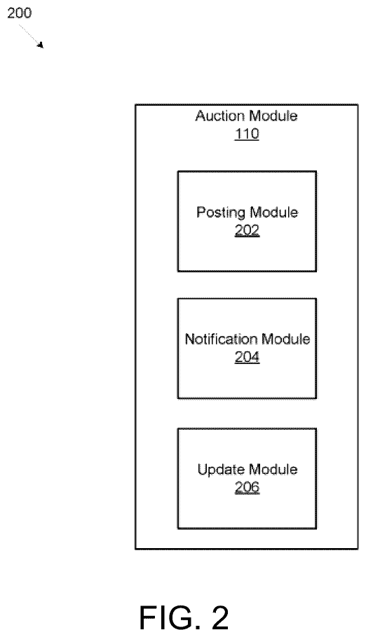

In one embodiment, an auction module 110, which at least a portion may be located on the auction management devices 102, the auction platforms 104a-n, and/or the information handling devices 106, facilitates the monitoring, maintenance, management, or the like of item listings on a plurality of auction platforms 104a-n. In one embodiment, the auction module 110 receives a notification comprising bid information, including a bid amount, for an auction item posted on a first auction platform 104a-n. In a further embodiment, the auction module 110 determines that the bid amount satisfies a reserve price for the auction item posted on the first auction platform 104a-n. In certain embodiments, the auction module 110 sends a notification to one or more second auction platforms 104a-n where the auction item is posted to remove auction listings for the auction item from the one or more second auction platforms 104a-n in response to the reserve price for the auction item being met at the first auction platform 104a-n. In alternative embodiments, the auction module 110 sends a notification to one or more second auction platforms 104a-n where the auction item is posted to indicate that the reserve price has been met, while keeping the auction listings active for the auction item from the one or more second auction platforms 104a-n in response to the reserve price for the auction item being met at the first auction platform 104a-n. As described below with reference to FIG. 2, the auction module 110 may utilize one or more different modules to perform the functions of the auction module 110.

In certain embodiments, the auction module 110 communicates with the various auction platforms 104a-n using web services, APIs, or other secure communications protocol mechanisms. As used herein, web services are methods of communication between two devices over a network 108a, 108b. Specifically, a web service is a software function provided at a network address where the web service is always on. Web services may integrate web-based applications using a modeling language (XML, JSON) to tag the data, a messaging protocol (SOAP or similar protocol) to transfer the data, a web service definition language (WSDL—typically XML-based) to describe the services that are available, and a registry (e.g., universal description, discovery, and integration (UDDI)—a platform-independent, XML-based registry) to where the web services can be listed.

The API layer in this multi-platform online auction system serves as a vital conduit responsible for facilitating secure and seamless communication and data exchange between different systems. Along with the decision engine, the API layer works to standardize the data, allowing the decision engine to interact with various disparate online auction platforms efficiently. Employing advanced encrypting techniques, stringent authentication protocols, and secure socket layer (SSL) integration, the API layer ensures the confidentiality and integrity of bid time and date during the transmission. The API layer can interpret and transfer bid data bidirectionally, ensuring compatibility and uniformity in secure communication protocols across the diverse set of online auction platforms involved in the multi-platform online auction with continuous bidding system. Emphasizing data exchange over centralization, this novel system facilitates a streamlined and continuous bidding experience across a spectrum of online auction platforms, showcasing its versatility and adaptability in integrated data from diverse sources. To optimize performance, the system employs lightweight and secure data transfer protocols, load balancing, and redundancy mechanisms, minimizing latency and mitigating risks. Real-time monitoring further enhances the system's responsiveness, guaranteeing continuous bid coordination across the multiple online auction platforms without compromising security or efficiency.

In some embodiments, certain auction platforms 104a-n may not be compatible with certain web services utilized by the auction module 110. Some auction platforms 104a-n may choose not to participate in continuous bidding. Using an auction module 110, a seller may choose not to include some auction platforms to participate in the auction. In any of these scenarios, these auction platforms 104a-n are considered “non-continuous bidding” auction platforms 104a-n because the auction platforms 104a-n may not be able to send, receive, and/or process updates to/from the auction module 110 or may choose not to participate in the continuous bidding process. Accordingly, in certain embodiments, when a bid for an item is received from a different auction platform 104a-n, the listing is removed from each non-continuous bidding auction platform 104a-n because the non-continuous bidding auction platforms 104a-n are not capable of receiving and sending updated bid notifications to/from the action module 110, have chosen not to participate in the continuous bidding process, or have been excluded from the auction by the seller.

On the other hand, auction platforms 104a-n that are compatible with the web services utilized by the auction module 110 and those auction platforms selected to participate by the seller at the auction module 110 are considered “continuous bidding” auction platforms 104a-n because the auction platforms 104a-n are capable of sending, receiving, and processing updates to/from the auction module 110. Accordingly, in certain embodiments, when a bid for an item is received from a different auction platform 104a-n, the listing for the item on the continuous bidding auction platforms 104a-n is updated to reflect the new bid price because the continuous bidding auction platforms 104a-n are capable of receiving and sending updated bid notifications to/from the action module 110.

FIG. 2 provides a schematic block diagram of one embodiment of a module 200 for management of a multi-platform online auction with continuous bidding. In one embodiment, the module 200 includes an instance of an auction module 110. The auction module 110, in some embodiments, includes one or more of a posting module 202, a notification module 204, and an update module 206, which are described in more detail below.

The posting module 202, in one embodiment, is configured to post a listing for an item for sale on a plurality of auction platforms 104a-n. The listing, in certain embodiments, may include various information describing the item for sale including the initial bid price, a reserve price (the lowest price the seller is willing to accept), an auction end time, a “buy now” price, a product description, images of the product, seller information, or the like. As described in more detail below, the create module 302 may facilitate the creation of an item listing at the auction module 110. For example, a user may create a listing for a vehicle that includes an initial bid price of $10,000, a reserve price of $10,000, an end date set for one week from the time the listing is posted, the vehicle identification number (“VIN”), images of the vehicle, and a description of the vehicle.

The posting module 202, as described above, may communicate with the particular various auction platforms 104a-n (as selected by the user) via a data network 108a using a web service to send the item listing to the selected auction platforms 104a-n. In response to receiving the listing for the item, the auction platforms 104a-n may post the listing on their respective interfaces, e.g., websites, for users to view and bid on.

In one embodiment, the notification module 204 is configured to receive a notification from an auction platform 104a-n in response to an auction event associated with the item listing. The auction event, in some embodiments, includes a bid for a listed item, a “buy now” purchase of the item, a question about the item, removal of the listing from an auction platform 104a-n, expiration of the listing of the item, or the like. The notification received by the notification module 204 may include the type of event and information associated with the event. For example, the notification module 204 may receive a bid notification, indicating that the listing received a bid from a bidder, and the amount of the bid, the new bid price, and/or the date/time of the bid.

In some embodiments, the notification module 204 receives notifications from auction platforms 104a-n synchronously or asynchronously in response to a message being sent to the auction platforms 104a-n. For example, in synchronous mode, certain messages sent to the auction platforms 104a-n may require a response before proceeding, and, therefore a notification would need to be received by the notification module 204 before processing could continue. On the other hand, in asynchronous mode, some messages may not require a response before proceeding, and therefore a notification would not need to be received by the notification module 204 before processing could continue.

The update module 206, in one embodiment, Is configured to update information for the listing on one or more different auction platforms 104a-n in response to receiving the auction event notification in real-time, meaning that the listing information for the item at an auction platform 104a-n is updated quickly such that the user is unaware that the auction platform 104a-n is communicating with the update module 206. For example, if the notification module 204 receives a bid notification, the update module 206 may push the information associated with the bid notification, such as the bid amount and the new bid price of the item, as well as the date/time of the bid, to the other auction platforms 104a-n that have a listing for the item so that the other action platforms 104a-n can update the bid information for the listing of the item. Similarly, if the notification module 204 receives a notification from an auction platform 104a-n that an item was purchased using a “buy now” option, the update module 206 may send an update to the other auction platforms 104a-n that have a listing for the item that the item has sold so that they can deactivate, remove, delist, or the like, the listing for the item.

In certain embodiments, if the notification module 204 receives a bid notification from any auction platform 104a-n, the update module 206 sends an update to the non-continuous bidding auction platforms 104a-n to remove the listing of the item because the non-continuous bidding auction platforms 104a-n are not participating or cannot participate in a continuous bidding auction due, at least in part, to the non-continuous bidding auction platforms' incompatibility with the web services being used by the auction module 110 or the platform being excluded from the auction by the seller. In some embodiments, if the notification module 204 receives a bid notification from a non-continuous bidding auction platform 104a-n, the update module 206 sends a notification to each of the other non-continuous bidding auction platforms 104a-n to remove the listing for the item except the auction platform 104a-n that received the bid because the auction platform 104a-n that received the bid is capable of receiving additional internal bids if and until a bid from a continuous bidding auction platform 104a-n is received.

In some embodiments, the update module 206 may provide data to the auction platforms 104a-n such that the auction platforms 104a-n may check and “pull” data for its listings. In one embodiment, the update module 206 may make accessible listing data, auction data, product data, seller data, or the like. The auction platforms 104a-n may send a request for certain data, and the update module 206 may send the requested data, if available, using a web service.

In another embodiment, an auction platform 104a-n that receives a bid for a listing may use a web service to pull data for the listing to check whether the received bid is the highest bid. If the received bid for the listing is the highest bid received from all the auction platforms 104a-n where the listing is posted, the update module 206 will lock the bid as the highest bid. If the received bid is not the highest bid for the listing, the update module 206 may send a message, notification, etc., to the auction platform 104a-n that received the bid to indicate that a different bid is currently the highest bid, e.g., a higher bid may have been received from a different auction platform 104a-n before the current bid was received. In certain embodiments, it may be beneficial to pull data where there occurs an outage in the system 100, or in particular at the auction platforms 104a-n, so that the auction platforms 104a-n can re-sync item listings by pulling data provided by the update module 206 and/or confirm that a received bid is the high bid prior to accepting the bid.

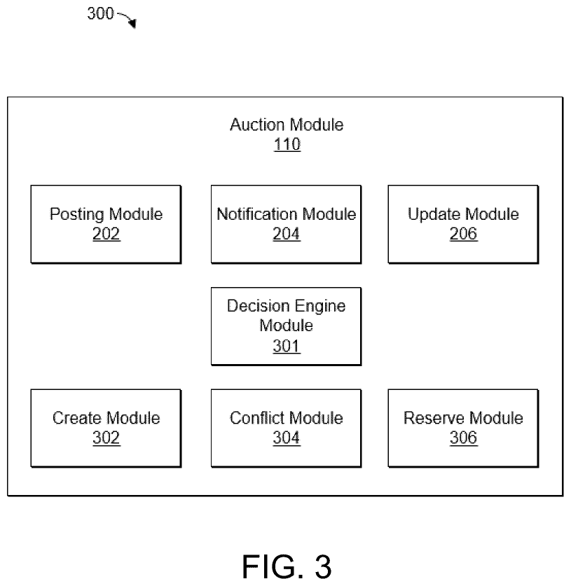

FIG. 3 provides a schematic block diagram of one embodiment of another module 300 for management of a multi-platform online auction with continuous bidding. In one embodiment, the module 300 includes an instance of an auction module 110 (which at least a portion of may be located on the auction management devices 102, as mentioned above). The auction module 110, in certain embodiments, includes one or more of a posting module 202, a notification module 204, and an update module 206, which may be substantially similar to the posting module 202, the notification module 204, and the update module 206 described above with reference to FIG. 2. In a further embodiment, the auction module 110 includes one or more of a decision engine module 301, create module 302, a conflict module 304, and a reserve module 306, which are described below.

The decision engine module 301, in one embodiment, may be configured to define conditions for executing one or more actions for affecting an operation of the disparate auction platforms, computing systems, networks, and databases, or may be configured to execute the one or more actions for affecting an operation of the disparate auction platforms, computing systems, networks, and databases. A decision engine may comprise a set of business or other rules, conditions, and events relating to specific auction platforms, or, optionally, more generally to all auction platforms. For example, rules-based data may specify that bids received from the second online auction platform can be synchronized with ongoing bids from the first online auction platform, thereby setting a rule on the requirement as to how bids are transferred between online auction platforms. And the decision engine can monitor bidding activity (e.g., bidding increments) on the first and second online auction platforms and execute the synchronization of bids, dynamically adjusting the bid increments on, for example, the second online auction platform to match the bid increments on the first online auction platform in order to, for example, encourage competitive bidding. In another example, rules-based data may identify limited or insufficient bidding on an item on a particular auction platform, where if bidding does not reach a certain threshold (e.g., at least 10 bids) on a particular auction platform, the decision engine would then generate addition listing data to list the item on at least one additional (e.g., third) auction platform, thereby potentially increasing exposure of the listed auction item to more bidders across a larger field of auction platforms. Optionally, the decision engine, via the rules-based data, would also generate instructions to remove the original, items listings having low or insufficient bidding. The rules-based data may also be applied to instruct the various disparate auction platforms how the interfaces and listing details/elements are configured, presented, or displayed as graphical user interface (GUI) elements on a GUI (e.g., on any of the information handling devices 106) to the bidder. The decision engine can (e.g., continually) analyze viewing and bidding patterns from the first and/or second auction along with addition information about the item (e.g., market information) and make a decision on the next best action for the item. The next best action for the item could involve, for example, changing a “buy now” price, reserve price, bid increment, removing the item from an auction, changing the auction parameters, duration, or venue, etc.

The decision engine serves as the orchestrator and incorporates a robust framework for standardization and governance within the multi-platform online auction system, ensuring the entire bidding process consistency across different online auction platforms. The decision engine is empowered by, for example, business rules that dynamically formulate and enforce bidding strategies on various auction sites simultaneously. By leveraging centralized business rules, the decision engine ensures that bidding strategies adhere to standardized protocols, promoting consistency across a diverse set of online auction platforms. The decision engine is like having an auctioneer in the traditional lane who knows the rules of each online auction platform and optimizes the bidding strategy accordingly. The decision engine will interpret real-time data, market trends, and platform-specific rules, making swift and informed decisions on when and how to post bids. The decision engine operates to implement platform-specific rules across multiple online auctions, ensuring a consistent and optimized bidding strategy. With the rules, the decision engine serves as the knowledge repository, housing the intricacies of each online auction platform's bidding regulations, constraints, options, capacities, capabilities, configurations, and nuances. Through continuous learning and updates, the rules, via the decision engine, adapt to changes in online auction platforms. The decision engine may employ algorithmic decision-making, considering factors like bidding increments, auction end times, and any specific limitations imposed by individual online auction platforms. The rules engine is programmed to understand the nuances of each platform, including items like start and end time of the auction. For example, when a user initiates a bid on a specific platform, the decision engine may consider the time differential between platforms, orchestrating bids to align within a unified timeline. The decision engine may calculate the optimal moment to commence bidding on each platform, factoring in their respective start times. The decision engine can do the same dynamic adjustments for specific site or platform strategies like auction end time. By dynamically interpreting these rules, the decision engine develops a synchronized approach, determining when and how to place bids across multiple online auction platforms.

Ongoing maintenance of the decision engine may involve regular review and systematic updates to the rules, refining or updating the platform-specific bidding regulations. Process governance may be enforced through protocols that validate and implement changes, ensuring the decision engine complies with industry standards. The system's adaptability to evolving industry standards and requirements is facilitated by the rules engine, allowing adjustments to be flexible for bidding rules based on evolving industry standards, auction platforms, market dynamics, or regulatory environment. This dynamic approach guarantees the continual effectiveness of the decision engine, adherence to process governance, adaptability to industry evolution, and the technical agility to maintain a reliable and optimized bidding experience across diverse and an evolving online auction landscape.

The create module 302, in one embodiment, is configured to create a listing for an item. The create module 302, in various embodiments, receives information from a user (via, for example, an inventory stored on an inventory database) regarding the product that the user is selling and creates a listing for the product that can be displayed on various auction platforms 104a-n. For example, if a user is creating a listing for a vehicle, the create module 302 may receive a description of the vehicle, one or more images of the vehicle, the VIN for the vehicle, the initial bid price, a “buy now” price, an auction end date/time, a reserve price, and/or the like. In certain embodiments, the create module 302 creates a listing using a modeling language, such as XML, which can be sent to the various auction platforms 104a-n by the posting module 202 using one or more web services/APIs. The create module 302 may retrieve the information about the vehicle stored on an inventory database. The create module 302 also uses platform-specific rules-based data from the decision engine module 301 to create the listing for the item for a particular auction platform.

In some embodiments, the auction end date/time is the same for each auction platform 104a-n to ensure that the length of the auction is consistent across all auction platforms 104a-n. In certain embodiments, the winning bidder is the bidder with the highest bid as of the auction end time. In a further embodiment, the update module 206 may update the listing information, including the auction end date/time, at any point during the auction. In one embodiment, if the notification module 204 receives a bid notification within a predetermined time of the listing's end date/time, the update module 206 extends the auction end date/time by a period of time, if that option is available to select by the user.

For example, if a bid is received within five minutes of the specified auction end date/time, the update module 206 may extend the auction end date/time by five minutes to account for processing delays and provide users of other auction platforms 104a-n an opportunity to bid on the product. In various embodiments, the auction ends a predetermined time after the initial auction end date/time to ensure bidding does not continue indefinitely. For example, an auction may have a hard stop time of thirty minutes such that the auction can only be extended up to thirty minutes past the originally specified auction end date/time. Again, this extension from the originally specified auction end date/time is optional and selectable by the user.

In some embodiments, the end date/time may be an absolute end date/time for a listing that has multiple iterations. As used herein, an iteration for a listing is the number of times, e.g., days, that a listing is posted on an auction platform 104a-n. For example, a vehicle listing may be posted to an auction platform 104a-n every day for seven days, as specified by the end date/time (assuming no bids are placed on the vehicle when it is posted). In some embodiments, the auction management devices 102 maintain, set, monitor, etc., the auction end date/time across multiple auction platforms 104a-n, and each auction platform 104a-n manages posting the listing for each iteration and performs its own end-of-sale processing if it is the auction platform 104a-n that received the winning bid.

In certain embodiments, after a listing is created by the create module 302, the posting module 202 posts the listing to a plurality of auction platforms 104a-n (via, for example, a secure communications protocol that utilizes a secure gateway, such as a secure communications protocol that comprises an API layer).

In response to the listing being posted at the auction platforms 104a-n, the notification module 204 may receive a listing notification from each auction platform 104a-n to confirm that the listing was posted. In some embodiments, the auction may not have started at a given auction platform 104a-n if the notification module 204 did not receive a listing notification from the given auction platforms 104a-n selected to host the listing. In other embodiments, the auction will begin regardless of whether a listing notification is received from one or more auction platforms 104a-n.

In some embodiments, if the notification module 204 receives a listing notification from an auction platform 104a-n after a bid notification has been received from a different auction platform 104a-n, the update module 206 sends updated bid information, such as the current bid price, to the auction platform 104a-n that sent the listing notification. This ensures that the correct bid information is reflected in the listing as soon as it is posted.

In one embodiment, if the notification module 204 does not receive a listing notification within a period of time after the posting module 202 sent the listing information and/or a posting error notification is received from an auction platform 104a-n indicating that the listing was not posted correctly, the posting module 202 may re-post the listing to the particular auction platform 104a-n.

The conflict module 304, in one embodiment, is configured to select a single bid from amongst a plurality of bids received substantially at the same time from different auction platforms 104a-n. As used herein, bids received substantially at the same time may mean bid notifications that are received by the notification module 204 within a predetermined time period of one another, such as 100 milliseconds, 500 milliseconds, 1 second, or the like, or bids that are received at different auction platforms 104a-n within a predetermined time period of one another. Accordingly, bid notifications may include a timestamp indicating when a bid was entered at an auction platform 104a-n.

The conflict module 304, in one embodiment, selects a single bid from amongst a plurality of bids received substantially at the same time by determining which bid was received first, but still within the time period that the bids are considered to be received at the same time. Thus, the conflict module 304 may determine which bid was received first by determining which bid was entered first at the auction platform 104a-n or which bid notification the notification module 204 received first, by, for example, utilizing the timestamps.

In one embodiment, the reserve module 306 is configured to determine whether a received bid amount satisfies a reserve price for an auction item listed at an auction platform 104a-n. As used herein, a reserve price is the minimum amount that the owner of an item up for auction will accept as the winning bid in the auction. In certain embodiments, the reserve price prevents the auction from being won by a bidder who offers a price lower than the item's owner will accept. In some embodiments, the reserve module 306 polls the auction platforms 104a-n at predetermined intervals to determine whether the reserve price has been met at the auction platforms 104a-n.

In certain embodiments, the reserve price is set as part of creating the auction item listing. The reserve module 306 may store the reserve price for an auction item at an auction platform 104a-n where the item is listed and/or at an auction management device 102. Thus, when a bid notification is received that includes the bid amount for the auction item, the reserve module 306: (1) checks at the auction platform 104a-n where the item is listed whether the received bid amount satisfies the reserve price for the auction item and sends a notification to the auction management device that the reserve price has been met; and/or (2) checks at the auction management device 102 where the notification of the bid amount is received to determine whether the bid amount satisfies the reserve price for the auction item and sends a notification to the auction platform 104a-n where the bid was received that the reserve price has been met. For instance, the reserve module 306 may compare the received bid amount to the reserve price at the auction management device 102.

In various embodiments, the auction platform 104a-n, e.g., a reserve module 306 located at an auction platform 104a-n, periodically polls the auction management device 102 to determine whether the reserve price for an auction item has been met at a different auction platform 104a-n. For instance, the reserve module 306 may poll the auction management device 102 every 30 seconds to determine whether the reserve price has been met at another auction platform 104a-n.

In some embodiments, when the reserve module 306 determines that the reserve price has been met, the notification module 202, the update module 206, and/or the reserve module 306 sends a notification to other auction platforms 104a-n where the auction item is posted that the reserve price has been met on the auction platform 104a-n, and instructs, triggers, commands, or the like the other auction platforms 104a-n to remove the auction item listing from the auction platforms 104a-n. In certain embodiments, the auction item listing is removed when the reserve price is satisfied even if there are additional iterations available for posting the auction item at the auction platform 104a-n. Alternatively, the notification to other auction platforms 104a-n where the auction item is posted may instruct, trigger, command, or the like the other auction platforms 104a-n to indicate that the reserve price has been met and to keep the auction item listing pending/active at these other auction platforms 104a-n in order to maximum exposure.

In one embodiment, after the reserve price is met at an auction platform 104a-n, and the auction item listing is subsequently removed from other auction platforms 104a-n, the auction platform 104a-n where the bid that satisfied the reserve price was received continues the auction for the auction item until the end of the auction, e.g., until the auction end date/time.

In one embodiment, the update module 306 extends the auction end time at each of the auction platforms 104a-n where the auction item is listed until a reserve price for the auction item is met. For example, if the auction item listing was scheduled to end on January 1, but the reserve price has not yet been met at any of the auction platforms 104a-n, the update module 306 may extend the auction end time at each of the auction platforms 104a-n for a predetermined period of time, e.g., a day, a week, a month, etc.

In one embodiment, notifications that include the reserve information, e.g., notifications for removing auction item listings from an auction platform 104a-n, in addition to the notifications discussed above (e.g., current bid price), are sent and received between an auction management device 102 and an auction platform 104a-n using various APIs. For instance, the auction management device 102 and the various auction platforms 104a-n may use different APIs for formatting, sending, and receiving notifications. For instance, the auction management device 102 may format messages that are sent to an auction platform 104a-n using the API of the auction platform 104a-n, and may convert messages received from an auction platform 104a-n from the auction platform 104a-n API format to a format compatible with the auction management device 102 API.

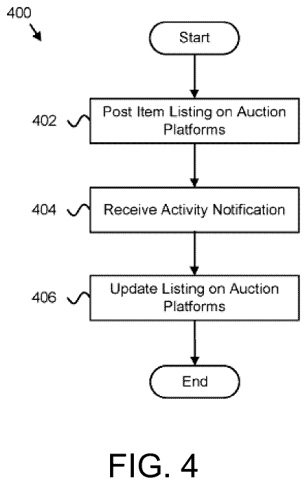

FIG. 4 provides a flowchart of one embodiment of a method 400 for management of a multi-platform online auction with continuous bidding. The method 400 begins and posts 402 a listing for an item for sale to a plurality of auction platforms 104a-n. In some embodiments, the posting module 202 performs the posting 402 of the listing for the item to a plurality of auction platforms 104a-n.

In a further embodiment, the method 400 receives 404 an activity notification from an auction platform 104a-n in response to an auction event associated with the item listing. An auction event may include a bid for an item, a purchase of an item (e.g., through a “buy now” option), a removal of the listing from the auction platform 104a-n, or the like. In one embodiment, the notification module 204 receives 404 the notification of an auction event associated with the listing.

In one embodiment, the method 400 updates 406 information for the listing on one or more different auction platforms 104a-n in response to receiving the notification. An update may include updating a bid price for an item on auction platforms 104a-n where the item is listed in response to the method 400 receiving a bid notification from a different auction platform 104a-n. Another update may include sending a message that the item has been purchased under a “buy now” option in response to the method 400 receiving a “buy now” notification so that the listing can be removed from the auction platforms 104a-n. In one embodiment, the update module 206 updates 406 information for the listing on the auction platforms in response to receiving the notification, and the method 400 ends.

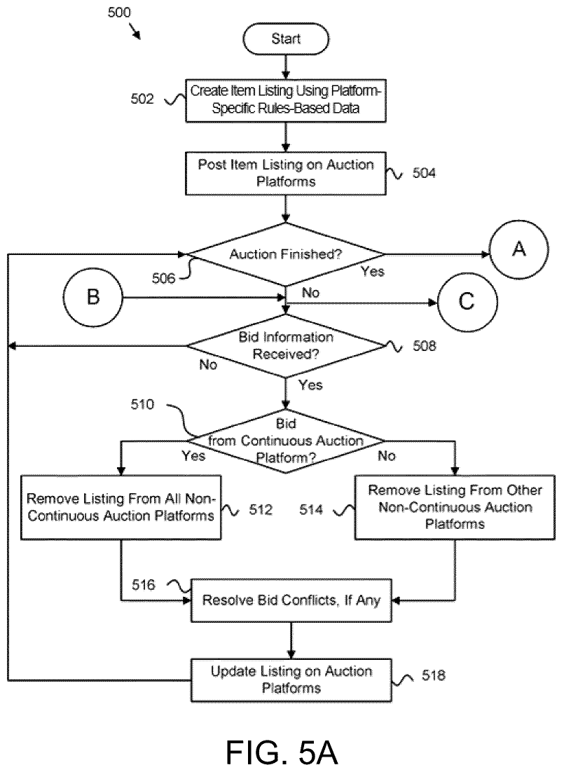

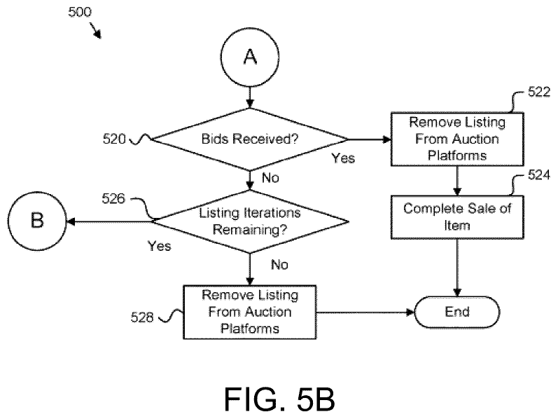

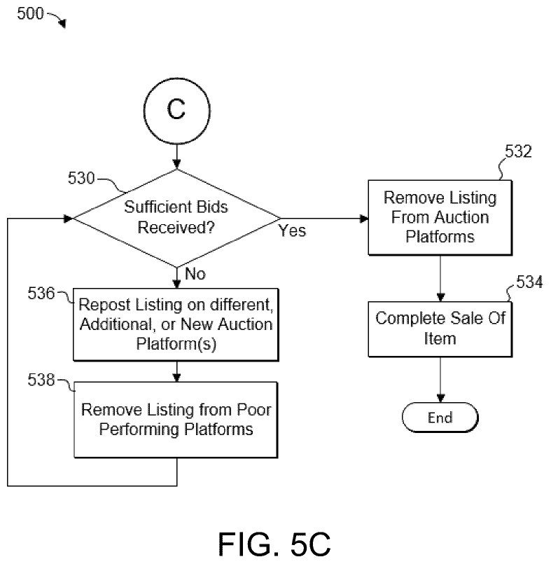

FIGS. 5A, 5B, and 5C provides a first portion, second portion, and third portion, respectively, of a flowchart of one embodiment of a method 500 for management of a multi-platform online auction with continuous bidding. In one embodiment, starting at FIG. 5A, the method 500 begins and creates 502 a listing for an item using platform-specific rules-based data. In certain embodiments, the method 500 creates 502 the listing for the item based in part on input received from a user, such as an item description, one or more images of the item, a starting bid price for the item, a “buy now” price for the item, information associated with the seller of the item, and/or the like. The method 500 also creates 502 the listing for the item based in part on rules-based data corresponding to information associated with a particular online auction platform. In some embodiments, the create module 302 creates 502 a listing for an item as described herein. In a further embodiment, the method 500 posts 504 (via, for example, a secure communications protocol) the item listing on one or more auction platforms 104a-n.

With more specificity, and with reference to the creation 502 and posting 504 of the item listing on one or more auction platforms 104a-n, the method 500, for example, may comprise: receiving an instruction to list an item (e.g., stored via an inventory database selected by the item seller (e.g., vehicle dealer)) on a first online auction platform and a second online auction platform, the instruction comprising information associated with the item; generating, via a decision engine, first listing data for the item, the first listing data based at least in part on the information associated with the item and at least in part on rules-based data corresponding to information associated with the first online auction platform; communicating, via a secure communications protocol, the first listing data to the first online auction platform; generating, via the decision engine, second listing data for the item, the second listing data based at least in part on the information associated with the item and at least in part on rules-based data corresponding to information associated with the second online auction platform; and communicating, via the secure communications protocol, the second listing data to the second online auction platform. The posting 504 may comprise the communicating step.

The information associated with the item may comprise at least one item parameter such as an authentication parameter, inventory data parameter, and/or pricing parameter. The authentication parameter may comprise, for example, a unique identifier (e.g., API key) for authentication, a secure token to validate the authenticity of the request, and/or the time zone in which the auction events are scheduled. The inventory data parameter may comprise, for example, a unique identifier (e.g., vehicle identification number (VIN) for each item, item details for identification (e.g., make, model, year), usage measurement of the item (e.g., mileage (odometer reading) or battery usage), description of the item's condition, and/or geographic location of the item. The pricing parameter may comprise, for example, an auction type (e.g., buy now, best offer, bid)), pricing type/amount (e.g., start price, reserve price, best offer price, buy now price), bidding increments, auction status (e.g., not yet started, pending, paused, didn't sell, ended), disclosures (e.g., vehicle announcements, recalls) pertaining to the item, and/or market data (e.g., information about market trends or conditions) associated with the item.

The information associated with the first online auction platform may comprise at least one platform parameter such as a platform-specific identifier, seller identifier, platform-specific timing/bidding detail, platform-specific authentication, platform-specific inventory data, platform-specific pricing information, platform-specific callback, platform-specific business rule, platform-specific security measure, platform-specific metadata, and/or platform-specific time zone. It is noted that the information associated with the second online auction platform may also comprise at least one platform parameter from this platform parameter group. The platform-specific identifier may comprise, for example, a unique identifier for the specific auction platform. The seller identifier may comprise, for example, a unique identifier for the seller (identifiable by the specific platform) and which may include custom settings and/or preferences for the seller. The platform-specific timing/bidding details may comprise, for example, an auction start time, auction end time, and/or specific bidding rules (e.g., expiry time of when a bid is valid). The platform-specific authentication may comprise, for example, a parameter for secure data transmission (e.g., SSL/TLS, API Key, and/or Token) and/or a parameter for data integrity verification. The platform-specific inventory data may comprise, for example, additional details required by the platform for listing items (e.g., specific condition categories, specific online auction platform, images format, and/or design layout of item listing). The platform-specific pricing information may comprise, for example, specific pricing structures and/or requirements for the specific platform. The platform-specific callbacks may comprise, for example, an Internet address to receive notifications or callbacks (via, for example, a URL) including, for example, an indication of the type of event triggering the callback (e.g., bid acceptance, auction closure). The platform-specific business (or other) rules may comprise, for example, parameters specifying conditions and/or actions based on decision engine logic (e.g., bid increment adjustments, listing extension, bidder engagement threshold, change in venue listed). It is noted that the rules-based data corresponding to information associated with the first online auction platform may be at least in part different than the rules-based data corresponding to information associated with the second online auction platform. The platform-specific security measures may comprise, for example, any security parameters and/or requirements imposed by the platform (e.g., data encryption, access control policies, anonymizing of bidder data between third parties, security auditing and monitoring). The platform-specific metadata may comprise, for example, any metadata required by the platform for listing and/or bidding. The platform-specific time zone may comprise, for example, a time zone specific to the scheduling of events on the specific platform.

In one embodiment, a time difference may exist between operation of the first online auction platform and operation of the second online auction platform, wherein the rules-based data corresponding to information associated with the first online auction platform and the rules-based data corresponding to information associated with the second online auction platform may consider the time difference in synchronizing bidding between the first online auction platform and the second online auction platform, thereby aligning bids between the first online auction platform and the second online auction platform within a unified timeline.

With reference to the posting 504 of the item listing on one or more auction platforms 104a-n, in one embodiment, the posting 504 may be performed via a secure communications protocol that utilizes a secure gateway. In one more specific embodiment, the secure communications protocol may comprise an API layer.

The method 500, in one embodiment, determines 506 if the auction is completed, which may be based on whether the product has sold, the end date/time of the auction has been reached, the end date/time of an iteration of the auction has been reached, or the like. If the method 500 determines 506 that the auction is not finished, the method 500 determines 508 if bid information has been received. If the method 500 determines 508 that bid information has not been received, the method 500 continues to monitor 508 for bid notifications while the auction is still live.

If the method 500, in one embodiment, determines 508 that a bid notification was received, the method 500 further determines 510 whether the bid notification was received from a continuous bid or non-continuous bid auction platform 104a-n. If the method 500, in another embodiment, determines 510 that the bid notification was received from a continuous bid auction platform 104a-n, the method removes 512 the item listing from the non-continuous bid auction platforms 104a-n. For example, the method 500 may send a message to the non-continuous bid auction platforms 104a-n indicating that a bid for the item has been received and that the item should be removed from the non-continuous bid auction platform's 104a-n listings.

If the method 500, in certain embodiments, determines 510 that the bid was not received from a continuous bid auction platform 104a-n, and therefore was received from a non-continuous bid auction platform 104a-n, the method 500 removes 514 the listing from other non-continuous bid auction platforms 104a-n that did not receive the bid. In a further embodiment, regardless of whether the bid notification was received 512, 514 from a continuous bid or non-continuous bid auction platform 104a-n, the method 500 resolves 516 any bid conflicts if two or more bids are received at substantially the same time.

In certain embodiments, as described above, the method 500 resolves 516 bid conflicts by selecting the bid that was received first based on when the bid notification was received from the auction platforms 104a-n. In certain embodiments, the conflict module 304 resolves 516 bids that are received at substantially the same time.

In one embodiment, the method 500 updates 518 the item listing on one or more auction platforms 104a-n where the listing is still active. The method 500, for example, may send the time/date of the received bid, the amount of the bid, the new bid price, or the like to the other auction platforms 104a-n, using one or more web services, so that the auction platforms 104a-n can update the information for the item listing. With respect to updates 518 of the item listing on one or more auction platforms 104a-n, the method 500, for example, may alternatively further comprise: receiving, at the decision engine, via the secure communications protocol, updated information associated with the item listed on the first online auction platform; generating, via the decision engine, updated second listing data for the item, the updated second listing data based at least in part on the updated information associated with the item listed on the first online auction platform and at least in part on the rules-based data corresponding to the information associated with the second online auction platform; and communicating, via the secure communications protocol, the updated second listing data to the second online auction platform. The updated information (parameters) associated with the item listed on the first online auction platform may comprise: a current bid price and/or any of the information parameters associated with the item described above.

With respect to updates 518 of the item listing on one or more auction platforms 104a-n, the method 500, for example, may additionally or alternatively further comprise: receiving, at the decision engine, via the secure communications protocol, updated information associated with the item listed on the second online auction platform; generating, via the decision engine, updated first listing data for the item, the updated first listing data based at least in part on the updated information associated with the item listed on the second online auction platform and at least in part on the rules-based data corresponding to the information associated with the first online auction platform; and communicating, via the secure communications protocol, the updated first listing data to the first online auction platform. The updated information (parameters) associated with the item listed on the second online auction platform may comprise: a current bid price and/or any of the information parameters associated with the item described above.

If the method 500 determines 506 that the auction is finished, the method 500 follows “A” to FIG. 5B and determines 520 whether any bids were received for the item. If the method 500 determines 520 that bids were placed on the item, the method 500 removes 522 the item listing from each auction platform 104a-n where the item is listed, and completes 524 the sale of the item at the auction platform 104a-n where the winning bid was received. Then the method 500 ends.

On the other hand, with respect again to FIG. 5B, if the method 500 determines 520 that no bids were received for the item, the method 500 determines 526 whether the listing still has iterations remaining. As explained above, iterations may refer to the number of times the same product and/or listing for a product may be presented at the auction platforms 104a-n. For example, a vehicle listing may have seven iterations, meaning that the vehicle listing may be listed at an auction platform each day for seven days up until the auction end/date time. Thus, if the method 500 determines 526 that the item listing does have iterations remaining, the method 500 follows “B” to FIG. 5A and determines 508 whether any bids have been received for the listing on the auction platforms 104a-n that reposted the listing for the new iteration. Otherwise, if the method 500 determines 526 that the listing does not have any remaining iterations available, the listing will not be reposted, and the method 500 removes 528 the item listing from each auction platform 104a-n where the item is listed. Then the method 500 ends.

In another embodiment, if the method 500 determines 506 that the auction is not finished, the method 500 follows “C” to FIG. 5C and determines 530 whether sufficient bids were received for the item. If the method 500 determines 530 that sufficient bids were placed on the item, the method 500 removes 532 the item listing from each auction platform 104a-n where the item is listed, and completes 534 the sale of the item at the auction platform 104a-n where the winning bid was received. Then the method 500 ends.

On the other hand, with respect again to FIG. 5C, if the method 500 determines 530 that sufficient bids were not received for the item (via poor performing platform(s)), the method 500 reposts 536 the listing on different, additional, or new auction platform(s). The method 500 then proceeds to remove 538 the listing from the poor performing platform(s). The method then proceeds to revert to determining 530 whether sufficient bids were received for the item.

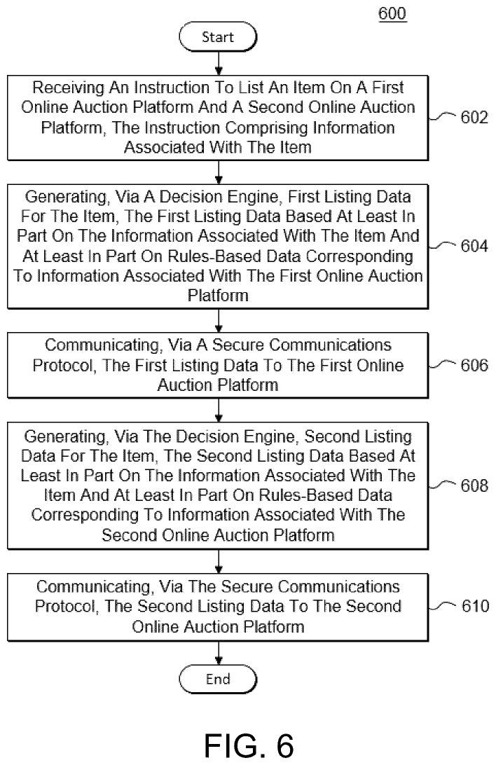

FIG. 6 provides a flowchart of one embodiment of a method 600 for management of a multi-platform online auction with continuous bidding. The method 600 begins and comprises: receiving an instruction to list an item on a first online auction platform and a second online auction platform, the instruction comprising information associated with the item (block 602); generating, via a decision engine, first listing data for the item, the first listing data based at least in part on the information associated with the item and at least in part on rules-based data corresponding to information associated with the first online auction platform (block 604); communicating, via a secure communications protocol, the first listing data to the first online auction platform (block 606); generating, via the decision engine, second listing data for the item, the second listing data based at least in part on the information associated with the item and at least in part on rules-based data corresponding to information associated with the second online auction platform (block 608); and communicating, via the secure communications protocol, the second listing data to the second online auction platform (block 610), and the method 600 ends.

In one embodiment, a non-transitory computer readable storage medium that stores computer code which, when executed by a processor, may perform any of the methods described herein. In another embodiment, a multi-platform online auction system may comprise: a processor; and a memory coupled to the processor to store code, which when executed by the processor, causes the processor to perform operations. The operations may comprise any of the methods described herein.

Acknowledging the existing challenges in traditional auction integration, this innovation addresses the need for enhanced efficiency, expanded sales channels, real-time adaptability to market changes, and a much-needed improvement to the buyer and seller experience. In response to the many limitations of online auctions and traditional physical auctions, this innovation introduces a sound solution with multi-platform auction integration that provides continuous bidding of the product being offered. The multi-platform strategy enables a more holistic approach to the online auction process. It holds several inherent benefits, including enhancing market reach with broader visibility while attracting a more diverse range of potential buyers. This expansion of online sales channels creates a competitive environment that drives up the value of the products being sold. Additionally, the strategy allows for adaptability to market changes, and mitigates the risk associated with platform-specific limitations.

The adaptive multi-platform online auction system described herein revolutionizes the auction landscape by seamlessly interconnecting various disparate online platforms through, for example, a robust and sophisticated API layer. There is a continuous flow of data in and out of the decision engine, allowing data to originate in any source (auction platform and/or inventory storage database) and pass-through to various online auction platforms. The rules-based data, via the decision engine, coordinates a unified bidding strategy, synchronizing bids across disparate online auction platforms. Ongoing maintenance, with a focus on bidding rules, ensures sustained efficiency, governed by robust process governance and a commitment to adaptability in response to an evolving industry. This innovation yields substantial advantages to sellers and dealers alike, minimizing cycle times, broadening sales channels, and providing flexibility in purchasing strategies. In summary, the adaptive multi-platform online auction strategy optimizes efficiency, accelerates turnover, and establishes a versatile, legally compliant ecosystem that transforms the auction process for everyone involved.

In any of the embodiments disclosed herein, continuous bidding may be achieved across multiple online auction platforms using the multi-platform online auction system or method set forth herein.

Although embodiments are described above with reference to disparate online auction platforms (e.g., having different bidding regulations, constraints, options, capacities, capabilities, configurations, and/or nuances), the methods and systems described in any of the above embodiments may alternatively comprise online auction platforms that are essentially identical. Such alternatives are considered to be within the spirit and scope of the present invention, and may therefore utilize the advantages of the configurations and embodiments described above.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A multi-platform online auction method comprising:
receiving an instruction to list an item on a first online auction platform and a second online auction platform, the instruction comprising information associated with the item;
generating, via a decision engine, first listing data for the item, the first listing data based at least in part on the information associated with the item and at least in part on rules-based data corresponding to information associated with the first online auction platform;
communicating, via a secure communications protocol, the first listing data to the first online auction platform;
generating, via the decision engine, second listing data for the item, the second listing data based at least in part on the information associated with the item and at least in part on rules-based data corresponding to information associated with the second online auction platform; and
communicating, via the secure communications protocol, the second listing data to the second online auction platform.

2. The method of claim 1, wherein the information associated with the item comprises at least one item parameter selected from the group consisting of an authentication parameter, inventory data parameter, and pricing parameter.

3. The method of claim 1, wherein the information associated with the first online auction platform comprises at least one platform parameter selected from the group consisting of a platform-specific identifier, seller identifier, platform-specific timing/bidding detail, platform-specific authentication, platform-specific inventory data, platform-specific pricing information, platform-specific callback, platform-specific business rule, platform-specific security measure, platform-specific metadata, and platform-specific time zone.

4. The method of claim 1, wherein the rules-based data corresponding to information associated with the first online auction platform is at least in part different than the rules-based data corresponding to information associated with the second online auction platform.

5. The method of claim 1, wherein a time difference exists between operation of the first online auction platform and operation of the second online auction platform, and wherein the rules-based data corresponding to information associated with the first online auction platform and the rules-based data corresponding to information associated with the second online auction platform consider the time difference in synchronizing bidding between the first online auction platform and the second online auction platform, thereby aligning bids between the first online auction platform and the second online auction platform within a unified timeline.

6. The method of claim 1, wherein the method further comprises:
receiving, at the decision engine, via the secure communications protocol, updated information associated with the item listed on the first online auction platform;
generating, via the decision engine, updated second listing data for the item, the updated second listing data based at least in part on the updated information associated with the item listed on the first online auction platform and at least in part on the rules-based data corresponding to the information associated with the second online auction platform; and
communicating, via the secure communications protocol, the updated second listing data to the second online auction platform.

7. The method of claim 6, wherein the updated information associated with the item listed on the first online auction platform comprises a current bid price on the first online auction platform.

8. The method of claim 7, wherein the rules-based data corresponding to information associated with the first online auction platform comprises a current bidding increment on the first online auction platform, and wherein the rules-based data corresponding to information associated with the second online auction platform comprises a bidding increment on the second online auction platform that is adjusted to match the current bidding increment on the first online auction platform, whereby the updated second listing data comprises the current bid price on the first online auction platform and the current bidding increment on the first online auction platform.

9. The method of claim 1, further comprising:
identifying, via the decision engine, limited bidding on the item on either the first online auction platform using the rules-based data corresponding to information associated with the first online auction platform or the second online auction platform using the rules-based data corresponding to information associated with the second online auction platform;
generating, via the decision engine, third listing data for the item, the third listing data based at least in part on the information associated with the item and at least in part on rules-based data corresponding to information associated with a third online auction platform; and
communicating, via the secure communications protocol, the third listing data to the third online auction platform.

10. The method of claim 9, further comprising:
generating, via the decision engine, instructions to remove the first listing data from the first online auction platform or the second listing data from the second online auction platform, based on the identification of the limited bidding on the item; and
communicating, via the secure communications protocol, the instructions to the first online auction platform to remove the first listing data, or the instructions to the second online auction platform to remove the second listing data.

11. A multi-platform online auction system comprising:
a processor; and
a memory coupled to the processor to store code, which when executed by the processor, causes the processor to perform operations, the operations comprising:
receiving an instruction to list an item on a first online auction platform and a second online auction platform, the instruction comprising information associated with the item;
generating, via a decision engine, first listing data for the item, the first listing data based at least in part on the information associated with the item and at least in part on rules-based data corresponding to information associated with the first online auction platform;
communicating, via a secure communications protocol, the first listing data to the first online auction platform;
generating, via the decision engine, second listing data for the item, the second listing data based at least in part on the information associated with the item and at least in part on rules-based data corresponding to information associated with the second online auction platform; and
communicating, via the secure communications protocol, the second listing data to the second online auction platform.

12. The system of claim 11, wherein the information associated with the item comprises at least one item parameter selected from the group consisting of an authentication parameter, inventory data parameter, and pricing parameter.

13. The system of claim 11, wherein the information associated with the first online auction platform comprises at least one platform parameter selected from the group consisting of a platform-specific identifier, seller identifier, platform-specific timing/bidding detail, platform-specific authentication, platform-specific inventory data, platform-specific pricing information, platform-specific callback, platform-specific business rule, platform-specific security measure, platform-specific metadata, and platform-specific time zone.

14. The system of claim 11, wherein the rules-based data corresponding to information associated with the first online auction platform is at least in part different than the rules-based data corresponding to information associated with the second online auction platform.

15. The system of claim 11, wherein a time difference exists between operation of the first online auction platform and operation of the second online auction platform, and wherein the rules-based data corresponding to information associated with the first online auction platform and the rules-based data corresponding to information associated with the second online auction platform consider the time difference in synchronizing bidding between the first online auction platform and the second online auction platform, thereby aligning bids between the first online auction platform and the second online auction platform within a unified timeline.

16. The system of claim 11, wherein the operations further comprise:
receiving, at the decision engine, via the secure communications protocol, updated information associated with the item listed on the first online auction platform;
generating, via the decision engine, updated second listing data for the item, the updated second listing data based at least in part on the updated information associated with the item listed on the first online auction platform and at least in part on the rules-based data corresponding to the information associated with the second online auction platform; and
communicating, via the secure communications protocol, the updated second listing data to the second online auction platform.

17. The system of claim 16, wherein the updated information associated with the item listed on the first online auction platform comprises a current bid price on the first online auction platform.

18. The system of claim 17, wherein the rules-based data corresponding to information associated with the first online auction platform comprises a current bidding increment on the first online auction platform, and wherein the rules-based data corresponding to information associated with the second online auction platform comprises a bidding increment on the second online auction platform that is adjusted to match the current bidding increment on the first online auction platform, whereby the updated second listing data comprises the current bid price on the first online auction platform and the current bidding increment on the first online auction platform.

19. The system of claim 11, wherein the operations further comprise:
identifying, via the decision engine, limited bidding on the item on either the first online auction platform using the rules-based data corresponding to information associated with the first online auction platform or the second online auction platform using the rules-based data corresponding to information associated with the second online auction platform;
generating, via the decision engine, third listing data for the item, the third listing data based at least in part on the information associated with the item and at least in part on rules-based data corresponding to information associated with a third online auction platform; and
communicating, via the secure communications protocol, the third listing data to the third online auction platform.

20. The system of claim 19, wherein the operations further comprise:
generating, via the decision engine, instructions to remove the first listing data from the first online auction platform or the second listing data from the second online auction platform, based on the identification of the limited bidding on the item; and
communicating, via the secure communications protocol, the instructions to the first online auction platform to remove the first listing data, or the instructions to the second online auction platform to remove the second listing data.
